(19) United States
(12) Patent Application Publication
(10) Pub. No.: US 2024/0159209 A1
(43) Pub. Date: May 16, 2024

(54) HYDROELECTRIC TURBINE INSTALLATION AND OPERATION METHOD FOR ENHANCING THE LEVEL OF DISSOLVED OXYGEN

(71) Applicant: VOITH PATENT GMBH, HEIDENHEIM (DE)

(72) Inventors: STUART COULSON, SEVEN VALLEYS, PA (US); STEVE MC HALE, HARRISBURG, PA (US)

(21) Appl. No.: 18/549,969

(22) PCT Filed: Feb. 15, 2022
(86) PCT No.: PCT/EP2022/053602

§ 371 Date: Sep. 11, 2023

Related U.S. Application Data
(60) Provisional application No. 63/159,546, filed on Mar. 11, 2021.

(51) Int. Cl. F03B 11/00; F03B 15/08

(52) U.S. Cl. CPC F03B 11/002; F03B 15/08; F05B 2220/64; F05B 2220/706

(57) ABSTRACT

A hydroelectric turbine installation includes a turbine, a water passage located upstream, a draft tube, a controller that controls operation conditions, a device for introducing oxygen-containing gas into water passing through the installation, a device for injecting water into the draft tube, and a device for controlling a flowrate of the water injected into the draft tube. The device for controlling the flowrate includes a control unit and a valve. The control-unit is configured to control the flowrate of the water injected into the draft tube in a way that the flowrate is a function of the operation conditions of the turbine. The flowrate set by the control unit at an operation condition of the turbine corresponding to an optimal efficiency point of the turbine is higher than a flowrate set by the control-unit at one or more other operation conditions of the turbine that do not correspond to an optimal efficiency point.

The present invention relates generally to hydroelectric turbine installations. More particularly, this invention pertains to hydroelectric installations with means for introducing oxygen containing gas into the water passing through the installation.

Dissolved oxygen is required to sustain aquatic life. Depending on the species, the threshold value may be 6 mg/I of dissolved oxygen or greater. In warmer periods with little river flow the dissolved oxygen stratifies in the reservoir upstream of the turbine and turbine inlet flow could be very low in dissolved oxygen (in some extreme cases levels of 0 mg/I have been recorded).

The level of dissolved oxygen in water passing a hydroelectric turbine installation depends of course on the amount of oxygen containing gas which is introduced into the water passing through the installation. Therefore the focus of prior art solutions for enhancing the amount of dissolved oxygen is on establishing means to ensure that the amount of introduced gas is high enough.

WO 2019/179742 A1 describes a runner of a hydroelectric turbine or pump with improved level of dissolved oxygen when backpressure increases. This is achieved by altering the geometry near the trailing edge of the runner to create a local drop in pressure on the trailing edge surface. The described runner comprises openings in the trailing edge surface to admit gas to the passing fluid during operation of the runner. The profile of the suctions side surface at the location of the openings is concave.

The inventors realized that there are other factors besides the amount of introduced gas which can influence the level of dissolved oxygen. When the gas is introduced into the water bubbles are formed. Oxygen is dissolved into the water by crossing the surface of the bubbles. For a given amount of gas introduced into the water the dissolving rate of oxygen will be proportional to the total surface of the generated bubbles. It is clear that the total surface of the generated bubbles is larger for smaller bubbles compared to larger bubbles. But the task is not done, when the generated bubbles are small at the point of time when the bubbles are formed. Bubbles in uniform water flows have the tendency to coalesce and to form in this way larger bubbles. Since the water flow in hydroelectric turbine installations at flow rates close to the optimum efficiency point is very uniform the effect of bubbles coalescing has a big negative impact on the level of dissolved oxygen. Since the main purpose of such hydroelectric turbine installations is to maximize electric power production, the operation conditions are normally controlled in a way to be as close to the optimum efficiency point as possible.

The objective of the present invention is to increase the level of dissolved oxygen downstream of the turbine over the level of dissolved oxygen achieved by state of the art when the turbine is operating at flow rates close to the optimum efficiency point.

The problem is solved by a hydroelectric turbine installation and a method according to the independent claims. Other favorable implementations of the invention are disclosed in the depended claims.

The invention will hereinafter be described in conjunction with the appended drawings:

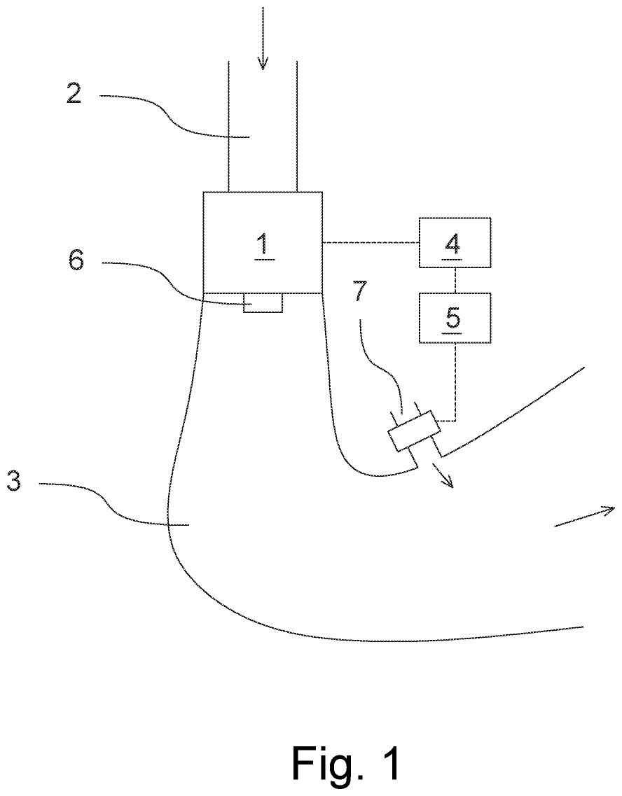

FIG. 1 Hydroelectric turbine installation according to the present invention;

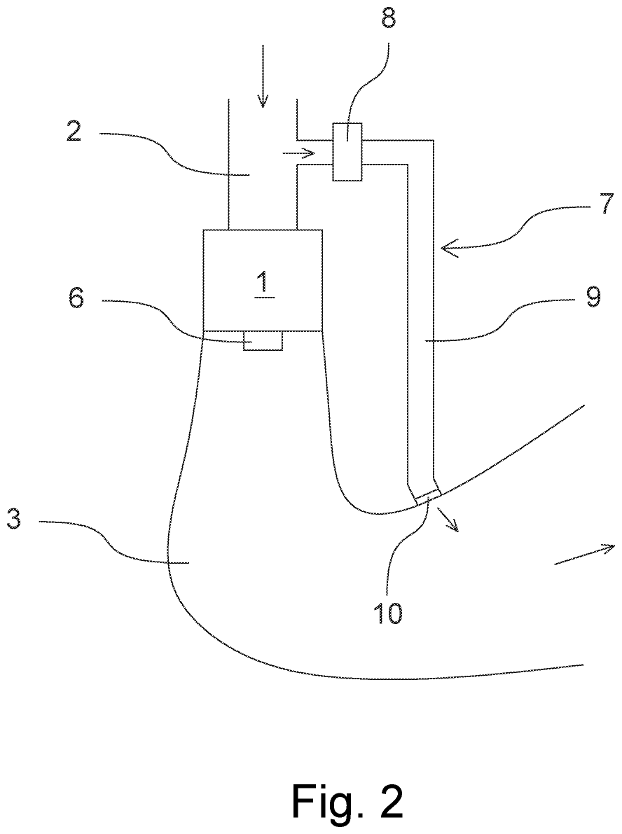

FIG. 2 Another embodiment of the present invention;

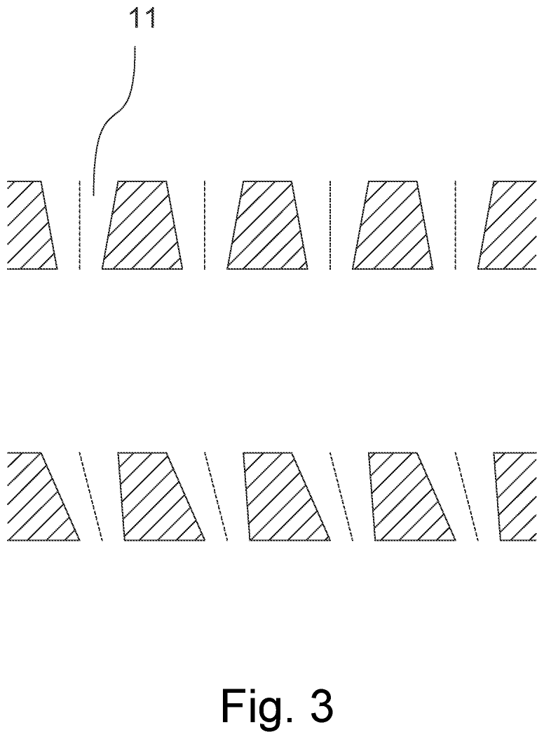

FIG. 3 Perforated cover plates;

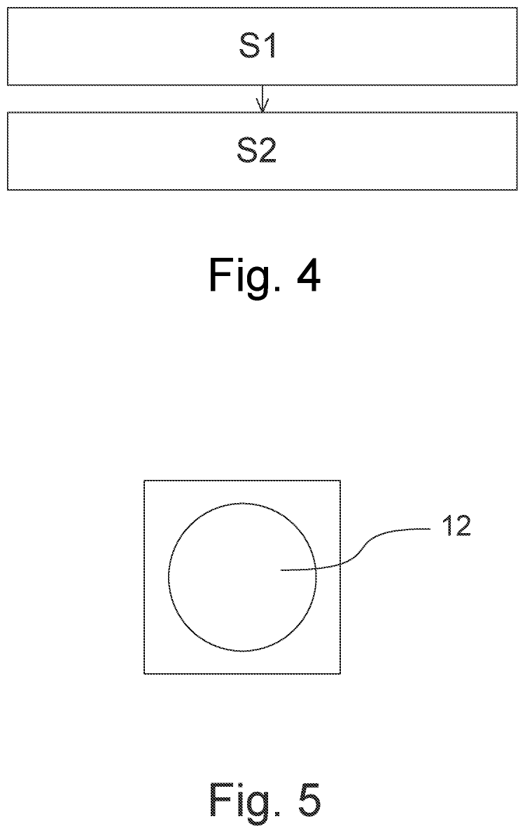

FIG. 4 Flow chart of the method according to the present invention;

FIG. 5 Data carrier.

FIG. 1 displays very schematically a hydroelectric turbine installation according to the present invention. The installation comprises a turbine designated as 1, a water passage located upstream of the turbine 1 and designated as 2, a draft tube located downstream of the turbine 1 and designated as 3 and means for controlling the operation conditions of the turbine 1 designated as 4. The installation comprises means for introducing oxygen containing gas into the water passing through the installation during operation of the turbine 1. These means are designated as 6. Means 6 can be located in any part of the installation such as turbine runner, wicked gates, draft tube 3 etc. The installation comprises further means for injecting water into the draft tube 3, whereas the injected water passes through one or more openings in the wall of the draft tube. In FIG. 1 the means for injecting water into the draft tube 3 are designated as 7. The one or more openings are located downstream of the means 6 for introducing oxygen containing gas into the water passing through the installation.

The installation comprises further means for controlling the flowrate of the water injected into the draft tube 3. These means comprise a control-unit designated by 5 and a valve. The control-unit 5 is designed to control the flowrate of the water injected into the draft tube 3 by controlling the valve position. By changing the valve position the control-unit 5 is varying the flowrate of the water injected into the draft tube 3. The control-unit 5 is further designed to control the flowrate of the water injected into the draft tube 3 in a way that the flowrate is a function of the operation conditions of the turbine, whereas the flowrate of the water injected into the draft tube 3 is higher when the operation conditions of the turbine are at or near the optimum efficiency point compared to operation conditions being away from the optimum efficiency point. To establish such a control of the flowrate of the water injected into the draft tube 3 the control-unit 5 is connected to the means 4 for controlling the operation conditions of the turbine 1. Of course means 4 and control-unit 5 can also be combined forming a single steering unit of a hydroelectric turbine installation according to the present invention.

The inventors have realized that by injecting a jet of water into the draft tube at operation conditions at or near the optimum efficiency point the smooth flow that occurs at these operation conditions is disturbed in order to shear air bubbles into smaller bubbles and cause re-circulations that will increase bubble travel time and thus increasing dissolved oxygen for a given gas/water volume fraction.

FIG. 2 shows another embodiment of the present invention. The means 7 for injecting water into the draft tube 3 comprise a water channel linking the water passage 2 located upstream of the turbine 1 to the draft tube 3. The water channel is designated as 9. The means 7 for injecting water into the draft tube 3 comprise further a valve, which is designated by 8 and which is located near the branching point from the water passage 2. The valve 8 can be located anywhere within the water channel 9. The purpose of the valve 8 is to control the water flow through the water channel 9. At the outlet of the water channel 9 into the draft tube a perforated cover plate is located, which is designated as 10. For the sake of simplicity means 4 for controlling the operation conditions of the turbine 1 and the control-unit 5 are not shown in FIG. 2.

When the valve 8 is opened high pressure water from the water passage 2 enters the water channel 9 and is injected into the draft tube 3 via the one or more perforations of the cover plate 10. In this way one or more crossflow water jets are directed into the draft tube flow to cause the desired flow disturbance.

It is of advantage that the outlet of the water channel 9 is located on the upper part of the draft tube 3 since this generates a larger volume of disturbed flow in the draft tube by impacting the downstream flow characteristics and thus has a larger impact on bubble shear and bubble travel time within the draft tube.

The water flowing through the water channel 9 into the draft tube 3 does not participate in the production of electric energy. It is therefore of advantage that the valve 8 is only opened when crossflow water jets are needed to increase the level of dissolved oxygen above the desired value. This is the case when the operation conditions of the turbine 1 are at or near the optimum efficiency point. The control-unit 5 is designed to control the flowrate of the water injected into the draft tube 3 in a way that the flowrate is a function of the operation conditions of the turbine. The simplest function achieving the desired behavior is therefore a plateau-shaped function varying from zero flowrate to a maximal flowrate (plateau value), whereas the plateau is located in a region of operation conditions around the optimum efficiency point. The function could also be a smooth function varying from zero flowrate to a maximal flowrate, whereas the maximal flowrate is reached at least at the optimum efficiency point. Alternatively the maximal flowrate could also be located at an operation condition corresponding not exactly to the optimal efficiency point of the turbine (that means, that the flowrate exactly at the optimal efficiency point could be slightly smaller than the maximal flowrate). In any case according to the present invention there has to be one or more operation conditions of the turbine corresponding not to the optimal efficiency point of the turbine, where the flowrate set by the control-unit 5 is lower than the flowrate set by the control-unit 5 at the optimal efficiency point of the turbine.

FIG. 3 shows cover plates in two different embodiments according to the present invention. In the embodiment shown on the upper part of FIG. 3 the cover plate comprises a plurality of perforations which are shaped like conical nozzles whereas the axes of the cones (dashed lines) are oriented perpendicular to the inner surface of the cover plate. The phrase inner surface relates to the surface of the cover plate which is orientated towards the inner of the draft tube. One of the perforations is designated as 11. The injected water jets will enter the draft tube in the direction of the axes of the cones. In the embodiment shown on the lower part of FIG. 3 the axes of the cones are inclined to the perpendicular direction by a non-zero angle. In this way the injected water jets can have a velocity-component which is orientated up- or downstream of the water flow within the draft tube. It is also possible that the injected water jets can have a tangential velocity-component related to the water flow within the draft tube. The embodiments shown in FIG. 3 are examples of a large number of possible embodiments according to the present invention. In other embodiments the perforations 11 could be for example shaped differently. In other embodiments the axes of the perforations 11 could be non-uniformly orientated to establish different entrance angles for the different injected water jets. Of course the surface of the cover plate facing inside the draft tube has not to be perfectly flat. It is of advantage that this surface of the cover plate forms a smooth junction with the inner surface of the draft tube.

FIG. 4 shows a flow chart of the method according to the present invention. The method is a method for operating a hydraulic turbine installation according to the present invention as described in the passages above. The method comprises at least two steps which are designated in FIG. 4 as S1 and S2. In step S1 the operation conditions of the turbine are set by the means for controlling the operation conditions of the turbine. In step S2 the control-unit sets the flowrate of the water injected into the draft tube whereas the flowrate is a function of the operation conditions set in step S1 as described above.

The present application is also related to a computer program designed to perform the steps of the described operation method. The present application is also related to a data carrier on which the computer program is stored. FIG. 5 shows a data carrier, which is designated by 12.

### LIST OF REFERENCES

1 Turbine
2 Water passage located upstream of the turbine
3 Draft tube
4 Means for controlling the operation conditions of the turbine
5 Control-unit
6 Means for introducing oxygen containing gas into the passing water
7 Means for injection water into the draft tube
8 Valve
9 Water channel
10 Cover plate
11 Perforation
12 Data carrier

1-11. (canceled)

12. A hydroelectric turbine installation, comprising:
a turbine, a water passage upstream of said turbine, and a draft tube downstream of said turbine;
a controller for controlling operation conditions of said turbine, and a device for introducing oxygen-containing gas into water passing through the installation during an operation of said turbine;
an injector for injecting water into said draft tube, with injected water passing through one or more openings in a wall of said draft tube; and
a flowrate controller for controlling a flowrate of the water injected into said draft tube, said flowrate controller having a control unit and a valve;
said control unit being configured to control the flowrate of the water injected into said draft tube as a function of the operation conditions of said turbine, with the flowrate set by said control unit at an operation condition of said turbine that corresponds to an optimal efficiency point of said turbine being higher than a flowrate set by said control unit at one or more other operation conditions of said turbine that correspond to an efficiency point of said turbine that is not an optimal efficiency point of the turbine.

13. The hydroelectric turbine installation according to claim 12, wherein said injector for injecting water into said draft tube comprise a water channel linking said water passage located upstream of said turbine to said draft tube and a perforated cover plate disposed at an outlet of said water channel into said draft tube.

14. The hydroelectric turbine installation according to claim 13, wherein said outlet of said water channel is located on an upper part of said draft tube.

15. The hydroelectric turbine installation according to claim 13, wherein said perforated cover plate is formed with one or more perforations each having a shape of a conical nozzle.

16. The hydroelectric turbine installation according to claim 15, wherein an axis of said one or more perforations is orientated perpendicular to an inner surface of said cover plate.

17. The hydroelectric turbine installation according to claim 15, wherein an axis of said one or more perforations is inclined relative to a surface normal of an inner surface of said cover plate by an angle other than zero.

18. The hydroelectric turbine installation according to claim 12, wherein the function of the operation conditions of said turbine is a plateau-shaped function varying from zero flowrate to a maximum flowrate, and wherein the region with the maximum flowrate is located at operation conditions around the optimal efficiency point.

19. The hydroelectric turbine installation according to claim 12, wherein the function of the operation conditions of said turbine is a smooth function varying from zero flowrate to a maximum flowrate, and wherein the maximum flowrate is reached at least at the optimal efficiency point.

20. A method of operating a hydroelectric turbine installation having a turbine, a water passage upstream of the turbine, and a draft tube downstream of the turbine, the method comprising:
providing a controller for controlling operation conditions of the turbine, a device for introducing oxygen-containing gas into water passing through the installation during an operation of the turbine, an injector for injecting water into the draft tube, with the injected water passing through one or more openings in a wall of the draft tube;
providing a flowrate controller for controlling a flowrate of the water injected into the draft tube, the flowrate controller having a control unit and a valve, and the control unit being configured to control the flowrate of the water injected into the draft tube;
setting the operation conditions of the turbine by the controller for controlling the operation conditions of the turbine;
setting with the control unit the flowrate of the water injected into the draft tube, with the flowrate being a function of the operation conditions of the turbine; and
thereby setting the flowrate by the control-unit at an operation condition of the turbine that corresponds to an optimal efficiency point of the turbine to a higher flowrate than at one or more other operation condition of the turbine which correspond to an efficiency point of the turbine that is not optimal.

21. The method according to claim 20, which comprises performing the step of setting the flowrate with a computer program executed on the control unit.

22. A computer program configured for integration into the method according to claim 20.

23. A non-transitory data carrier encoded with executable instructions of a computer program which, when executed, cause the controller and the control unit to perform corresponding steps of claim 20.
